(19) United States
(12) Patent Application Publication
(10) Pub. No.: US 2009/0063318 A1
(43) Pub. Date: Mar. 5, 2009

(54) Reconciling Asset Attributes Values Before Saving to Asset Database

(75) Inventors: Jason Aron Alonzo, Fair Oaks, CA (US); John Leong Yee, San Mateo, CA (US); Umesh Madhav Apte, San Ramon, CA (US)

Correspondence Address: AKA CHAN LLP / ORACLE, 900 LAFAYETTE STREET, SUITE 710, SANTA CLARA, CA, 95050, US

(73) Assignee: ORACLE INTERNATIONAL CORPORATION, Redwood Shores, CA (US)

(21) Appl. No.: 11/848,588

(22) Filed: Aug. 31, 2007

(51) Int. Cl. G06Q 40/00

(52) U.S. Cl. 705/35

(57) ABSTRACT

Discrepancies between two sets of asset information for an organization are identified and reconciled before saving to a database. One set of asset information may be compiled using automatic physical discovery software while the other set is from a financial system of the organization. After discrepancies are identified, the user may review the differences and make changes before saving. The process may be performed in real time or in batch.

### BACKGROUND OF THE INVENTION

This invention relates to the field of asset management and more specifically, to a technique of reconciling proposed asset information for a financial system with asset information which has been compiled through a physical or automatic discovery technique.

Large organizations often have trouble keeping track of their assets. The assets are purchased and deployed throughout the organization and then become increasingly difficult to account for. Accounting of these assets is necessary to maintain compliance with regard to leases, material financial impact of the assets, and software license compliance among other things. Often times, an organization will rely on the information that is stored in their financial system. However, this rarely reflects the real world of assets that are actually deployed within the organization. This information lacks the impact of events, such as asset disposal, unrecorded sales, theft, and so forth.

Increasingly, organizations are deploying asset tracking (i.e., physical or automatic discovery) mechanisms that can retrieve the actual asset information as it is utilized in the organization. Typically, the asset tracking data varies from the information stored in the financial system, and it is desirable to reconcile any discrepancies.

Organizations want to take the information that comes from the discovery system and reconcile it back to their financial system (i.e., an asset repository). Especially in a large organization, this can become very burdensome and time-consuming because there are potentially a large number of discrepancies to check and reconcile. Finding both simple errors (e.g., typographical, incorrect identification of asset information type) and larger errors (e.g., incorrect entries into the asset repository) are hidden from the user and require manually spotting differences between proposed asset information and the discovery system and then accessing the financial system to reconcile the asset information. And, in the time it takes to reconcile asset information in this manner, more changes in the asset information may have occurred, further requiring the financial system to be updated.

Therefore, there is a need for a technique to facilitate the reconciliation of discrepancies in asset information. It would be beneficial to allow entry into a financial system as proposed asset information and note the differences between the proposed asset information and the discovery system in real-time to a user. Additionally, it is beneficial to give the user, who is likely in the best position to verify asset information, the capability of saving the asset to the financial system.

### BRIEF SUMMARY OF THE INVENTION

Discrepancies between two sets of asset information for an organization are identified and reconciled before saving to a database. One set of asset information may be compiled using automatic physical discovery software while the other set is from a financial system of the organization. After discrepancies are identified, the user may review the differences and make changes before saving. The process may be performed in real time or in batch.

A system of the invention allows greater visibility into discrepancies throughout an asset's life. In an implementation, the system provides a reconciliation tab to the user that adds and maintains assets. Users will be empowered to make better decisions about the asset. They will have real time or near real-time reconciliation information and can verify any mistakes regarding the asset before they are introduced to the system (e.g., saving to an asset database).

A system of the invention will increase the efficiency of the overall reconciliation process. Not only will the reconciliation process be looking at real-time discovery data and its differences from the proposed asset information, but the system will also put that information to users most able to resolve differences. For instance, this user would be placed in the best position to check for typographical errors and also to relieve some of the discrepancy congestion caused by simple differences created when the data entered is close to the retrieved data but is not exactly correct.

Proposed asset information for entry may be provided as a manual one-by-one asset information entry (e.g., a user manually types each asset information at a time) or in any batch format. This set of proposed asset information then waits to be possibly saved into the asset repository. Another set of asset information may be compiled using automatic discovery software. The system presents a user a list of differences between the two sets of asset data and allows the user to choose how to reconcile the asset information.

In a specific implementation, the invention is a method including: providing proposed asset information to be entered into a first repository; and before entering the proposed asset information into the first repository, comparing the proposed asset information with asset information in a second repository to find any discrepancies.

Further, in various implementations, the method includes: if there are no discrepancies, entering the proposed asset information into the first repository; and if there are discrepancies, showing the discrepancies between the proposed asset information with asset information in a second repository. The method includes: after comparing the proposed asset information with the second repository and before entering the proposed asset information into the first repository, providing a user interface that allows altering of the proposed asset information. The method includes: entering into the first repository either the proposed asset information without alteration or the proposed asset information with alterations made using the user interface.

The method includes: after the comparing the proposed asset information to the second repository, seeking an approval from the user to enter the proposed asset information into the first repository; receiving an approval from a user, entering the proposed asset information into the first repository. The method includes: showing the discrepancies between the proposed asset information with asset information in a second repository; and after receiving an approval from a user, entering the proposed asset information into the first repository. The proposed asset information to be entered may include multiple assets. The method includes: performing an automated asset discovery process to generate the second repository including discovered asset information.

In a specific implementation, the invention is a method including: providing proposed asset information to be entered into a first repository; if a first condition is satisfied, entering the proposed asset information into the first repository; and if the first condition is not satisfied and before entering the proposed asset information into the first repository, comparing the proposed asset information with asset information in a second repository to find any discrepancies.

In various implementations, the first condition is satisfied when the proposed asset information is not found in the second repository. The first condition is satisfied when the proposed asset information is indicated as not being in the second repository. The method includes: if a second condition is satisfied, entering the proposed asset information into the first repository; and if the second condition is not satisfied, showing the discrepancies between the proposed asset information with asset information in a second repository. The second condition is satisfied when there are no discrepancies.

In a specific implementation, the invention is a method including: providing proposed asset information and discovery asset information; comparing the proposed asset information to the discovery asset information; displaying on a first screen an indicator of a discrepancy between the proposed asset information and the discovery asset information; in the first screen, allowing a user to make changes to the proposed asset information; and after allowing the user to make changes to the proposed asset information, saving the proposed asset information with any changes to an asset repository database.

In various implementations, the providing proposed asset information initiates a synchronous communication resulting in the comparing the proposed asset information and discovery asset information. The proposed asset information is stored in a temporary memory location. The method includes: before displaying the first screen, displaying a second screen for the user to enter the proposed asset information, where the second screen includes a user-selectable option, and when the user-selectable option is not selected, the proposed asset information is saved to the asset repository without performing the comparing the proposed asset information and discovery asset information. In the first screen, moving a mouse cursor over an indicator of a discrepancy shows discovery asset information. The discovery asset information is compiled through automatic discovery. The first screen has a link, when selected, causes displaying of a second screen where the proposed asset information is provided in a first column and the discovery asset information is provided in a second column, adjacent to the first column.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a block diagram of a client-server system and network in which an embodiment of the invention may be implemented.

FIG. 2 shows a more detailed diagram of an exemplary client or computer which may be used in an implementation of the invention.

FIG. 3 shows a system block diagram of a client computer system used to provide a user interface according to the invention.

FIG. 4 shows data source or data service in the form of a database system.

FIG. 5 shows an overview of an asset management system of the invention.

FIG. 6 shows a single asset entry data flow for the invention.

FIG. 7 shows a multiple asset entry data flow for the invention.

FIG. 8 shows a flow diagram of an implementation of invention which accepts and handles entry of proposed asset information in various formats.

FIG. 9 shows a sample computer screen where proposed asset information is entered and discrepancies are indicated.

FIG. 10 shows another example of an asset information computer screen.

FIG. 11 shows another example of an asset information computer screen.

### DETAILED DESCRIPTION OF THE INVENTION

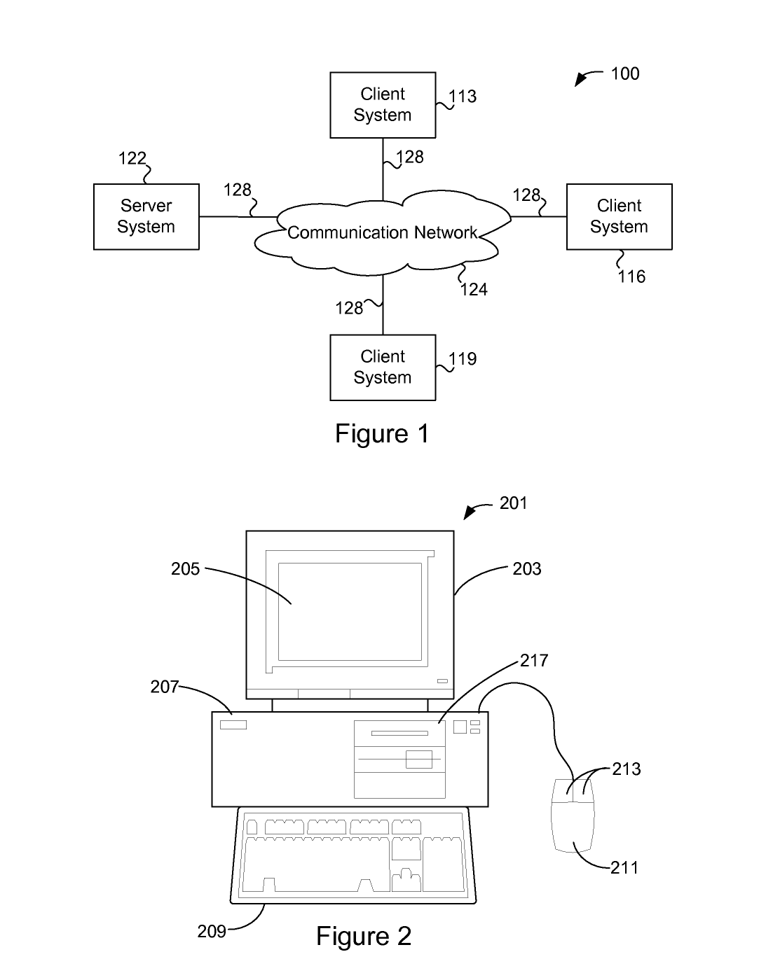

FIG. 1 is a simplified block diagram of a distributed computer network 100 which may include an implementation of the present invention. Computer network 100 includes a number of client systems 113, 116, and 119, and a server system 122 coupled to a communication network 124 via a plurality of communication links 128. There may be any number of clients and servers in a system. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Various communication protocols may be used to facilitate communication between the various systems shown in FIG. 1. These communication protocols may include TCP/IP, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, a intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both as a client or a server depending on whether the computer system is requesting or providing information. Additionally, although aspects of the invention has been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

According to the teachings of the present invention, client systems 113, 116, and 119 enable users to access and query information stored by server system 122. In a specific embodiment, a “Web browser” application executing on a client system enables users to select, access, retrieve, or query information stored by server system 122. Examples of web browsers include the Internet Explorer browser program provided by Microsoft Corporation, and the Firefox browser provided by Mozilla Foundation, and others.

FIG. 2 shows an exemplary client or server system of the present invention. In an embodiment, a user interfaces with the system through a computer workstation system, such as shown in FIG. 2. FIG. 2 shows a computer system 201 that includes a monitor 203, screen 205, cabinet 207, keyboard 209, and mouse 211. Mouse 211 may have one or more buttons such as mouse buttons 213. Cabinet 207 houses familiar computer components, some of which are not shown, such as a processor, memory, mass storage devices 217, and the like.

Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive), battery-backed-up volatile memory, tape storage, reader, and other similar media, and combinations of these.

A computer-implemented or computer-executable version of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

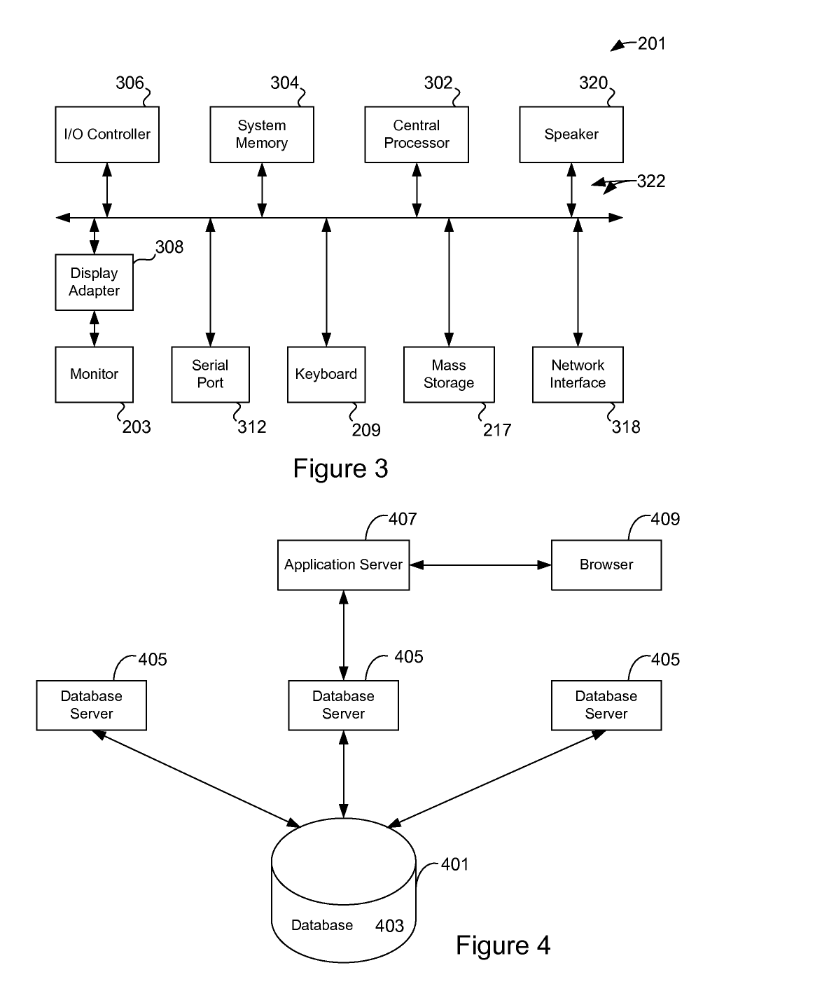

FIG. 3 shows a system block diagram of computer system 201 which may be used to execute software of the present invention. As in FIG. 2, computer system 201 includes monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 2 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems).

An operating system for the system may be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

FIG. 4 shows a data source or data service in the form of a database system. A database may be part of a database management system. One suitable database management system architecture is a three-tiered architecture as shown.

In a first tier is the core of a database management system, a central storage 401 that holds or stores a database or repository 403. The database typically resides on one or more hard drives, and is generally part of a larger computer system. The information may be stored in the database in a variety of formats. An example is a relational database management system (RDMS) which uses tables to store the information.

In a second tier are database servers 405. The database servers are instances of a program that interacts with the database. Each instance of a database server may, among other features, independently query the database and store information in the database. Depending on the implementation, the database servers 405 may or may not include user-friendly interfaces, such as graphical user interfaces.

In a third tier is an application server 407. There may be multiple application servers. In an implementation, the application server provides the user interfaces to the database servers. By way of example, the application server may be a web application server on the Internet or any other network. The application server may also be a virtual database server or a virtual directory server. The application server may provide user-friendly mechanisms and interfaces for accessing the database through the database servers. In an implementation, a web browser 409 is utilized to access the application server.

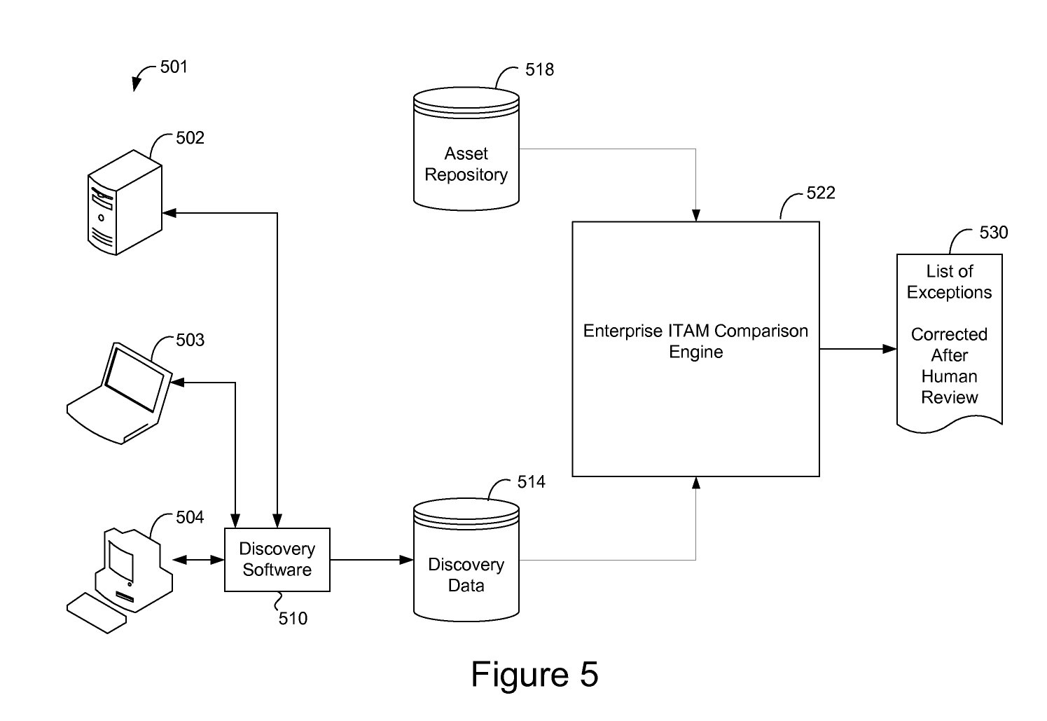

FIG. 5 shows an overview of an asset management system of the invention. The system tracks assets 501 including servers 502, laptops 503, computers 504, and other systems or devices. Discovery software 510 finds the assets of the system and records the asset tracking information received from the devices in a database, discovery data 514, or other data repository. For example, the discovery software connects to the network, dynamically collects asset information including the physical attributes or attribute values of the assets, and stores the asset information found in discovery database 514. In an implementation, when a device connects to the system network, the discovery software inquires and receives asset information.

The asset information (e.g., physical attributes or attribute values of an information technology asset) may include information such as serial number (e.g., 61RC5B1), manufacturer (e.g., Dell, HP, Compaq, IBM, Lenovo, Acer, Shuttle, ASUS), model (e.g., Latitude D620, Presario), primary user (e.g., John Doe, Jane Smith), location (e.g., third floor, building E, Pleasanton, Calif.; seventh floor, suite 710, Santa Clara, Calif.), machine type, network address of machine, machine name, user configured physical attributes or attribute values (such as RAM, CPUs, or number of CPUs or cores), and software installation and usage.

Discovery data 514 is a first set of asset information for an organization. This first set of asset information may be referred to as discovered asset information or dynamic asset information since the information is discovered dynamically using software. Any automated technique of determining the assets of a network may be used. The discovery data may be updated periodically.

In the organization, there is typically a second set of asset information that has been input separately, perhaps as part of the financial system (i.e., an asset repository). In typical operation and use of assets, some of the asset information may change due to employee turnover, internal employee transfers, theft, and obsolescence. Moreover, for example, when an asset is purchased, asset information is input into an asset repository or other database 518. This second set of asset information may be referred as input asset information or static asset information, which contrasts with asset information that is dynamically discovered using software.

There may be discrepancies between the dynamic and static sets of asset information. For example, typographical or other user errors may occur when inputting the static asset information. When a computer was first purchased, it was assigned to a particular department, but then transferred to a different department. The dynamic asset information may show the computer as part of the new department, but the static asset information has not yet been updated.

A laptop may be physically transferred to a retained employee after another employee is laid-off; however, the new custodian of the asset may not be updated in the static asset information. An asset may be purchased and deployed and never captured in the static asset repository. The computer may have additional software installed without authorization getting recorded in the static system. Additionally, computers may get used in a mode where four physical CPUs work as eight virtual CPUs and it is likely that static asset repository may not have captured it.

A comparison engine 522 compares discovery data 514 (i.e., dynamic asset information) against the asset repository data 518 (i.e., static asset information) and determines differences in the asset information. The determined differences are provided to the user in a list 530, table, or other format. This list may be printed or provided on the computer screen. The user can review the differences and manually enter corrections.

A rule-based approach to automatically reconciling the static asset information and dynamic asset information is presented in U.S. patent application Ser. No. 11/774,969, filed Jul. 9, 2007, which is incorporated by reference.

An important issue to address is how to correct in the asset information a typographical error in the asset's serial number. The asset's serial number is a high level key often used as the information by systems to compare the assets. Therefore, if the serial number is typed incorrectly, the system will have difficulty in identifying that the asset in the financial system has a counterpart in the discovery system.

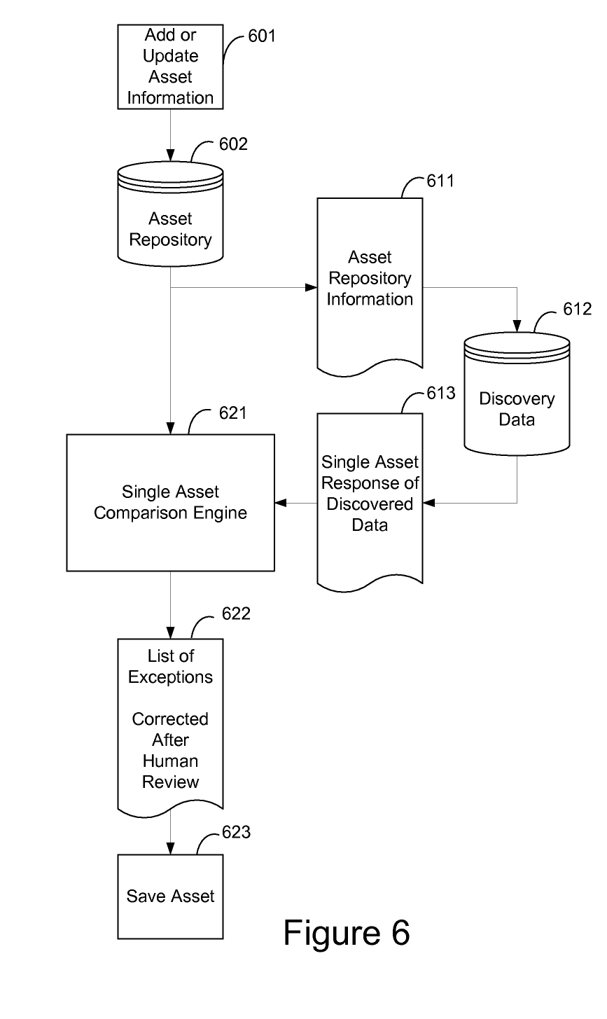

FIG. 6 shows a single asset entry data flow for the invention. In a step 601, a person or user enters some proposed asset information for entry to an asset repository or database 602. In this flow, the user enters a single entry at a time. In another flow (discussed below), proposed asset information may also be entered or specified through multiple entries at a time (such as by using a data file or data table). And in yet another flow (discussed below), a system or technique of the invention handles a single entry or multiple entries at a time, or a combination of these.

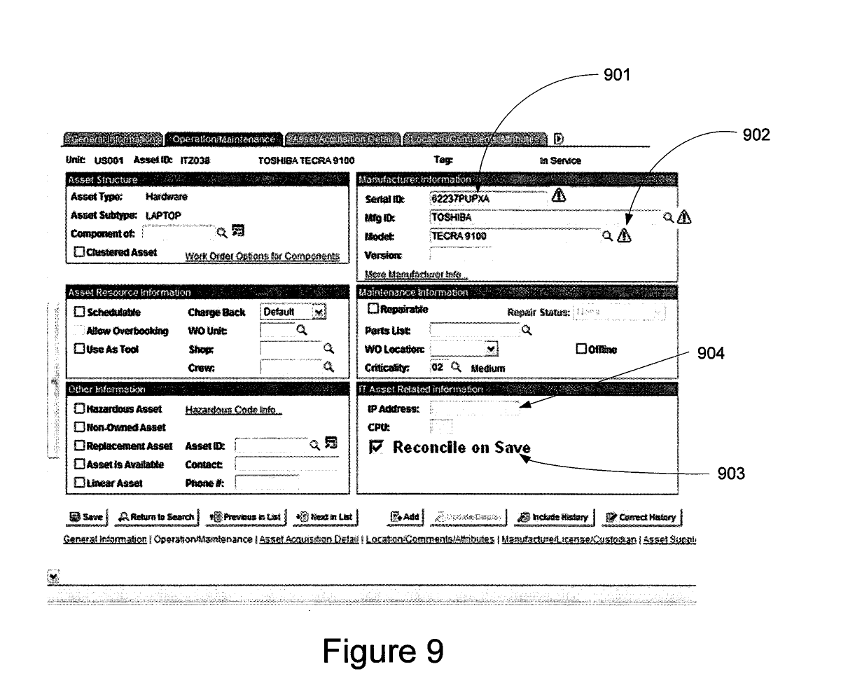

The user may enter the information into a system of the invention using any number of input techniques. For example, information may be entered using a keyboard and mouse via a graphical user interface (GUI) entry screen on a computer display. The entry screen may show a number of entry fields; the user can tab or use the mouse to select an appropriate entry field and then enter data. FIG. 9 shows a sample asset data entry screen. Other input devices (e.g., controllers, joysticks, touch pads, keypads, or bar code readers) or techniques (e.g., voice recognition) may be used. Additionally, information may be directly transferred or obtained from the vendor or distributor (or other third party source) of the asset. For example, the user may select an asset to be entered and then entry fields will be automatically populated with the information obtained from a third party source. In implementation, the proposed entries are specified using a document, data file, database, or data table. FIG. 9 shows a sample computer entry screen.

Upon entry of the proposed asset information, the information may be held or stored in memory (e.g., cache, RAM, Flash, or hard disk), temporary memory, or other buffer or memory area (i.e., a stored proposed asset information 611). Or, the proposed asset information may be stored in the asset repository or in a temporary location within the asset repository.

A discovery data database 612, compiled through an asset discovery process, is searched to see if something corresponding to proposed asset information 611 is in the discovery database. The discovery database may be compiled through third-party software or other automated method for asset information gathering. Depending on the circumstances, the proposed may or may not have been discovered by the discovery process. For example, the proposed asset has not yet been connected to the network, so the discovery process does not find it.

A response of the search 613 is delivered to a single asset comparison engine 621. The search may be performed using any element or combination of elements of the proposed asset information. For example, the search may be performed to find a serial number match.

Further, in an implementation, the system may suggest matches based on data from the discovery data as to which discovery data asset is most like the entered proposed asset information. For example, if every asset attribute between the proposed asset information and discovery data is correct except for one or a few attributes (e.g., model type), the system will match the assets together.

In an implementation, searching is performed based on an asset key, typically the unique serial number of the asset. The search will match the serial number of the asset being added to the asset repository with the serial number of the discovered assets. Serial numbers, by their nature, should be unique and only one matching asset should exist; however it is possible to have more than one physical asset that has the same asset key. This could occur through cloning an asset where the serial number is incorrectly copied across a number of assets when asset images (like configurations needed on a number of machines) are deployed. Additionally, there is the random possibility that two unique assets could be assigned the same serial number. In either case, the discovery system will implement reporting and safeguards to ensure the uniqueness of the assets in the system. In the case where they are unable to insure uniqueness, either the discovery system or the comparison engine can produce an error indicating that more than one matching asset was found.

Some discrepancies will involve human review such as, for example, when an asset is found in the asset repository and an equivalent asset is not found in the discovery system. It is possible that an incorrect serial ID has been entered into the asset repository system (i.e., perhaps caused by a typographical error). While the two assets are the same, it may not be possible for the comparison engine to recognize that. The action to correct the discovery system serial ID should to be done manually.

Another example of where human intervention is likely called for, but not required, is a scenario where a new computer gets allotted to an employee who does not use it for a few weeks and continues to use the employee's old computer. Associated actions with the business rule may be to either move the old computer to inventory or to retire an asset. Both actions probably need human review and most likely would not be performed automatically.

If a corresponding entry to proposed asset repository information 611 is found in the discovery database, the comparison engine will do a comparison between the two and provide a list of exceptions 622 to the user. For example, the exceptions are displayed on a computer display for the user. The discovered serial number or location of the machine may not match the information entered by the user for the proposed entry. There may be one or more discrepancies for a single proposed asset information. FIG. 9 shows a sample computer screen where discrepancies are highlighted with an indicator 902.

Specific flow implementations for reconciliation of asset information are presented in this patent, but it should be understood that the invention is not limited to the specific flows and steps presented. A flow of the invention may have additional steps (not necessarily described in this application), different steps which replace some of the steps presented, fewer steps or a subset of the steps presented, or steps in a different order than presented, or any combination of these. Further, the steps in other implementations of the invention may not be exactly the same as the steps presented and may be modified or altered as appropriate for a particular application or based on the data.

In the flow of FIG. 6, the user will review and correct any discrepancies in the proposed asset repository information, and then save the new asset entry 623 to the asset repository. At this point, the proposed asset repository information, if held in a temporary location or buffer, will be moved or saved to the asset repository for storage. The flow is repeated each time the user enters new proposed asset information.

If the proposed asset information is not found in the discovery database, this fact may be displayed to the user and user can then approve entry of the proposed asset information into the asset repository. In an alternative implementation, once the proposed asset information is not found in the discovery database, the entry can be automatically entered into the asset repository without the user's approval.

In an implementation, after the user enters the proposed asset repository information, the search and comparison to the discovery data and displaying of exceptions is done in real time. The user will not have to wait overnight, such as in a batch processing, to see the results. For example, the user will enter proposed asset repository information and hit “go.” Then a short time later (perhaps almost instantaneously, depending on the processing or network speed, or both), the results are displayed to the user.

In an implementation, the search and comparison are performed using a synchronous communication (e.g., synchronous message, synchronous thread, or web service). For example, the entry of the proposed new asset information is performed and starts a synchronous communication (the request and response of the discovery data). The entry of the proposed new asset information waits for the synchronous request and response to return information before continuing. When the response is received, the system displays any discrepancies on the screen. In this example, the local processing system opens a communication channel with the discovery system and does not continue working until it has sent a request and received a response (synchronous communication).

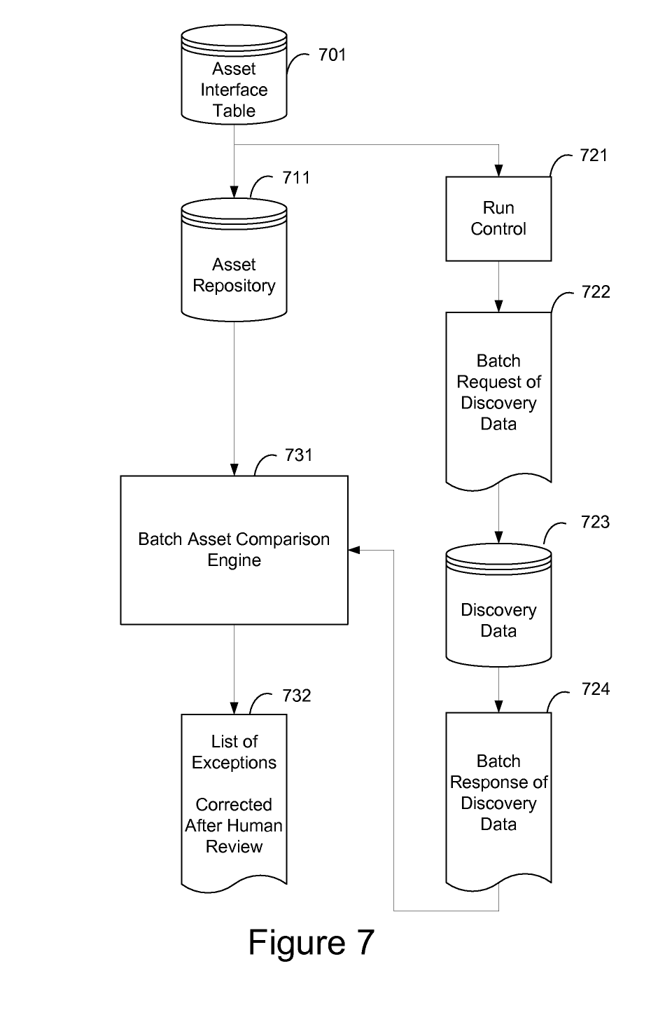

FIG. 7 shows a multiple asset entry data flow for the invention. Compared to the flow implementation in FIG. 6, in this flow, multiple entries of proposed asset information 701 are entered in at a time (rather than single entries at a time) for an asset repository 711.

As in the single entry implementation, the multiple proposed entries may instead be stored in a temporary memory location, rather than stored in the asset repository directly or immediately. The entries may be held or stored in memory (e.g., cache, RAM, Flash, or hard disk), temporary memory, or other buffer or memory area. Or, the proposed asset information may be stored in a temporary location within the asset repository. Alternatively, the proposed entries may be stored directly in the asset repository, and perhaps indicated using a flag or Boolean field as new entries which have not yet been checked.

The flow may be performed in real time, but depending on the number of entries, the wait time for the user may be very long. Therefore, in an implementation, the flow is done using batch operation. Batch processing can be particularly beneficial when checking certain asset information type at once (e.g., for all asset type hardware and asset subtype LAPTOP). This batch information is collected and entered into the system by various methods (e.g., manual entry into a list for invention, through a spreadsheet file, through a handheld scanning device that compiles the information from barcodes on the assets). Batch processing typically uses an asynchronous communication or asynchronous thread approach.

To facilitate greater ease in entering of multiple proposed asset information, the entries may be specified using a document, data file, database, or data table. Each data file can include two or more entries. For example, data is stored in a file or other document in a specific format such as comma-delimited format, comma-separated values (CSV) format, delimiter-separated values format, spreadsheet format, word processor format, database format, binary format, plain text format, ASCII format, HTML format, XML format, or other formats. In an implementation, a technique or system of the invention takes input from any number of entry techniques or different formats and handles this input by parsing through the data and populating the asset repository appropriately.

A run control process 721 handles receiving multiple entries of proposed asset information and initiates requests 722 or searches a discovery database 723 for corresponding discovery data for the proposed assets information. The run control may monitor changes in the contents of the asset interface table and initiate queries of the discovery database. The run control may be executed continuously or at intervals. Executing the run control in intervals (e.g., by manual execution, continuous execution as a background process, execution on a schedule) may be desirable for network, system, energy, or other efficiency reasons.

The run control process receives a batch response of asset information 724 from the discovery database. This response includes the entries which are determined during the search to correspond or match the proposed entries. As discussed above, some or all proposed entries may not be found in the discovery database.

A batch asset comparison engine 731 compares discovery asset information response 724 against the proposed asset information. The comparison process generates a list of exceptions or discrepancies 732 between the discovery data and proposed asset data. For example, this list of discrepancies may be displayed on a computer screen. The user can review the exceptions, make corrections as needed, and then approve entry of the proposed entries into the asset repository. At this point, the proposed asset repository information, if held in a temporary location or buffer, will be moved or saved to the asset repository for storage. The flow is repeated each time the user enters new proposed asset information.

If one or more proposed asset entries are not found in the discovery database, this fact may be displayed to the user and user can then approve entry of these proposed asset entries into the asset repository. In an alternative implementation, once some of the proposed asset entries are not found in the discovery database, these entries can be automatically entered into the asset repository without the user's approval. Other proposed asset information that are found in the discovery system will require approval before entering into the asset repository. A user-selected option may be used to select manual or automatic entry of not found entries.

In an implementation, the system waits until a specific number of differences or checked entries of asset information are generated 732 before presenting a list to the user. The specific number of differences or checked entries may be system specified or user selected or specified. For example, the specific number may be a number (e.g., 1, 2, 3, 4, 5, 10, 20, 30, 40, 50, 60, or other) of differences or checked entries, number of screen pages, file size, or amount of date (e.g., bytes, kilobytes, megabytes, or gigabytes). Using this approach, information is presented to the user in batch, rather then piecemeal, which a user can review more efficiently.

In a further implementation, the list of differences is presented to the user in user-defined batches (e.g., display list for all asset subtype of LAPTOP) or whenever an entire table is processed by the system.

In yet another implementation the assets are added to the asset repository despite the differences found by the comparison. As the user reviews the asset repository through the normal course of business the discrepancies can be viewed as shown in FIGS. 9, 10 and 11. This implementation provides discrepancy data to users through an interface which they are already familiar. As they review the asset or plan to make changes (the original reason for opening the asset record) they are alerted to other differences. They can then investigate or make necessary changes to further align the asset repository with the discovered system without a lot of overhead.

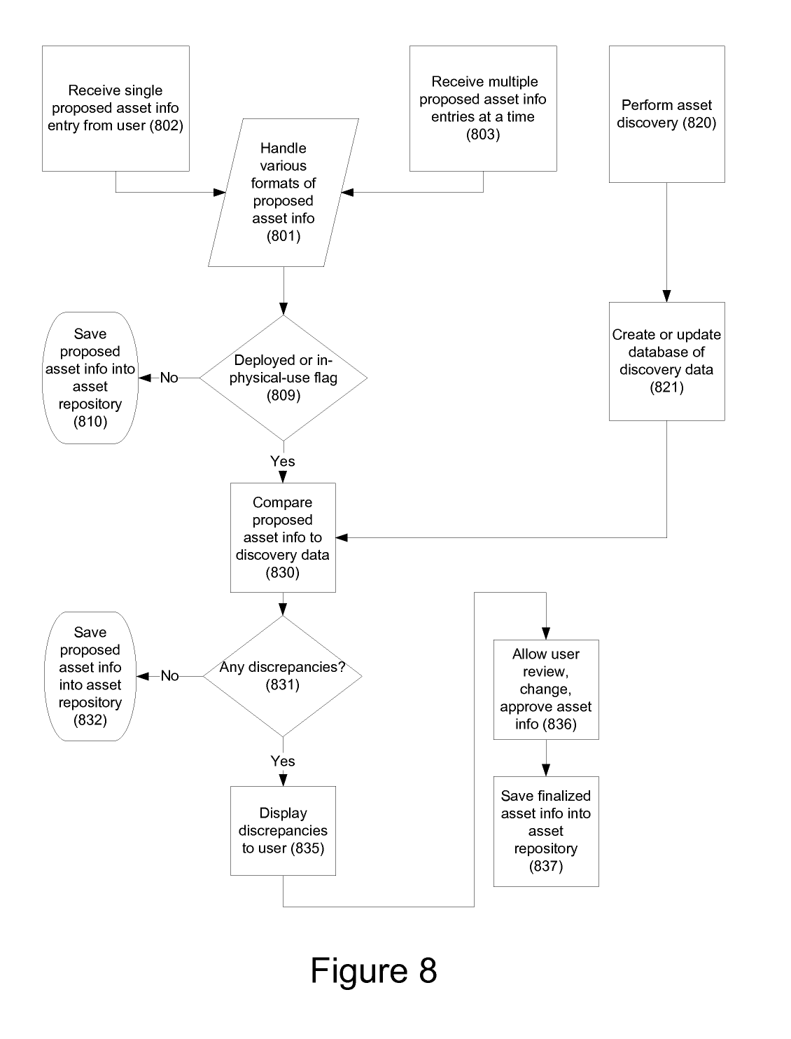

FIG. 8 shows a flow diagram of an implementation of invention which accepts and handles entry of proposed asset information in various formats. Aspects of the invention discussed in connection with the flows in FIGS. 6 and 7 are also applicable to this flow.

In this flow, the system accepts and handles proposed asset information 801 provided in two or more different formats including single entry 802 (see FIG. 6 and accompanying discussion) or multiple entries 803 (see FIG. 7 and accompanying discussion). As discussed above, single entries and multiple entries may be handled in real time or batch. Entries may be provided in any format including direct input, bar code reader input, data file input, database, transfer from another source such as third-party source, and document. This entering of proposed asset information may be referred to a first process.

As discussed above, the proposed asset information may be stored directly in the asset repository, and indicated as not having been checked against the discovery data yet. Alternatively, the proposed asset info may be stored in a temporary memory location, instead of stored to the asset repository immediately.

In a step 809, the user is provided an option to indicate whether the asset is deployed or in physical use. This feature is optional in a flow of the invention. If this feature is not available, the flow proceeds to the next step (i.e., step 830). When this feature is available, the user may select indicate that an asset has or has not been deployed. The user may indicate this by checking or not checking a box, setting a Boolean variable to a logical 0 or 1, a Boolean flag to false or true, or other similar technique.

If the asset has not been deployed or is not in physical use, the deployed flag is not set. The proposed asset info will not be checked against the discovery data and the proposed asset information is saved to the asset repository 810. Since the asset has not yet been deployed, the discovery process would not have found the asset and added the physical information to the discovery database. Therefore, going through the comparison process is not needed. If the deployed flag is set (or enabled), then the flow will proceed to the next step.

Similar to step 809, there may be other flags or options to allow the user to select whether they want to go through with a comparison between the proposed asset info and discovery data, delay the comparison, or select between real time or batch operation, reconcile on save (i.e., upon hitting the save button, the user wants a reconciling of the proposed asset information to the discovery data to be performed; see FIG. 9 which shows a reconcile on save check box 903), or any combination of these or other options. Any of these options may be used in place of or in conjunction with the deployed flag. These flags or options may be checked before the comparison or later point in the flow, including after the comparison is made.

Such options allow the user more flexibility in operation of the system. Performing a comparison may take some time, and the user may want to skip the comparison entirely or want to delay the comparison until a later time. For example, the proposed asset information may come directly from the manufacturer and there is little likelihood of having incorrect entries, so the user wants to skip the comparison process altogether.

An aspect of the invention is that the reconciliation process is run at user-selected or preset times or intervals (e.g., run the reconciliation every two weeks at 12 a.m.). The user may specify a starting time (e.g., 1a.m., 2 a.m.) or time period (e.g., 3-4 a.m., 4-7 a.m.) when the comparison or reconciliation will be done. When complete, the user may be notified by e-mail, instant message, or text message to a mobile phone, or a combination of these or other options.

This may improve hardware efficiency. By scheduling the process to automatically correct discrepancies when computing hardware is utilization is less, it will free up the hardware at a time when demand is high for computing cycles. The system will thus be able to better handle those actions that require user intervention to correct because the volume will have been lowered.

Another process of the invention is a discovery process in steps 820 and 821 which automatically gathers and updates asset data in a discovery database. The discovery process runs asynchronously with other steps (e.g., 802, 803, 801, 809, and 830). This discovery process may be referred to as a second process. In a step 820, the system executes an asset discovery process which searches through a network to find assets attached to the network. As assets are found, the discovery database is updated or created 821. In a specific implementation of the invention, the asset discovery process 820 is continuous run, so that information in the discovery database 821 is accurate to near real-time. In other implementations of the invention, the discovery process is performed at scheduled intervals such as periods of time when the system load is less.

In a step 830, the system takes the proposed asset information from the first process and compares against the discovered asset information from the second process. In a step 831, the system determines if there are any discrepancies. A discrepancy occurs when a particular attribute of a proposed entry does not match the corresponding attribute of a corresponding entry in the discovery data.

Discrepancies can be found in a system for a number of reasons. The purchasing system, for example, can regularly populate the asset interface tables with information from purchase orders. Each purchase order may designate a department or user that should receive the asset. However for operational or other reasons, different departments and users may actually end up with the assets. Additionally there may be feeds that populate the interface tables that do not have all of the asset information that is available to the discovery system. For example, a feed may populate the asset information without the model information, as it may not be known. The lack of the model information would produce a discrepancy whereby the discovered model information could be added to the repository. Other examples were provided above.

If no discrepancies are detected between the two sets of information, the flow proceeds to a step 832. In step 832, the system saves the asset information in the asset repository. When saving, the proposed asset repository information, if held in a temporary location or buffer, will be moved or saved to the asset repository for storage. The flow is repeated each time the user enters new proposed asset information.

If discrepancies are detected between the two sets of information, the flow proceeds to a step 835, where the discrepancies or differences are displayed on a computer monitor or other display to the user. In a step 836, the user reconciles the asset information by reviewing, changing, and approving the asset information differences. Once the user approves, in a step 837, the finalized asset entry (or entries if multiple entries were provided) is saved to the asset repository.

Steps 835 and 836 are optional. Alternatively, after step 831 (instead of steps 835 and 836), the flow allows the user to save the proposed asset information with discrepancies if the user desires. The review and correction of discrepancies is optional and not required.

In a step 835, if there are discrepancies between the two sets, the differences are presented by the invention to the user 835. Invention allows user to reconcile the asset information by allowing user to review, change, and approve of asset information differences 836 and saves the reconciled information into the asset repository 837.

FIG. 9 shows a sample computer screen where proposed asset information is entered and discrepancies are indicated. Through various tabs, specific asset information are organized and emphasized for ease of comparison. In this sample screen, the tabs include general information, operation/maintenance, asset acquisition detail, and location/comments/attributes. Other implementations of the invention may have any number of tabs, similar or different from the ones shown in this figure. For example, in an implementation, a computer screen of the invention includes a tab that allows a side-by-side comparison (e.g., in columns) of the asset information from the asset repository to the discovery data.

This screen has multiple fields (e.g., entry box 901 is for serial ID or serial number of an asset) each with information about a particular asset's information type. In other implementation, there may be additional fields for other asset information. The fields may be arranged in order. The system may allow a user to add fields that are not provided natively by the system.

In this computer screen, an indicator (e.g., 902) is used to indicate when a particular attribute that is entered does not match the corresponding discovery data entry. The system may alert the user of discrepancies using a visible alarm (e.g., highlighting fields, flashing screen or text, different colors, boxes around fields, or placing alert icons next to fields), an audible alarm (e.g., beep, buzz, music, user-selected sound or jingle, MP3 song, or computer-generated voice specifying an asset), or other alerting technique.

For example, to highlight or otherwise draw attention to a particular field, a color of the field is changed. For example, the IP address field is highlighted in yellow (or other color different from the other fields) while the other fields are in white.

The system may provide additional information when there is a discrepancy. For example, when mousing (or hovering) over an alert icon or the field indicated has having a discrepancy, the system will show the discovery database information so the user can see what the differences are between the proposed data and the discovered data. As a further example, the system provides an audio message on the differences in an asset attribute.

This computer screen allows the user to specify certain options such as checking a reconcile-on-save check box 903. By checking this box, the user indicates to the system that the system should do a reconciliation with the discovery data before saving the proposed asset information to the asset database. Otherwise, the proposed asset information need not be checked and the save can be performed without reconciling.

As discussed above, there may be other flags. For example, a bypass flag may be desirable so that this asset is entered into the asset repository without any reconciling the data. This may be useful when the asset is not yet deployed.

In a specific implementation, the system restricts which users have access to the capability to reconcile the asset information. Additionally, the invention may restrict which users have capability to view asset differences (e.g., the warning flags).

In a specific implementation, the system includes an option to not allow automatic reconciliation for certain conditions. For example, the user may specify a range of IP addresses where automatic reconciliation is not performed. These IP addresses may be addresses for virtual private network (VPN) or remotely connected users.

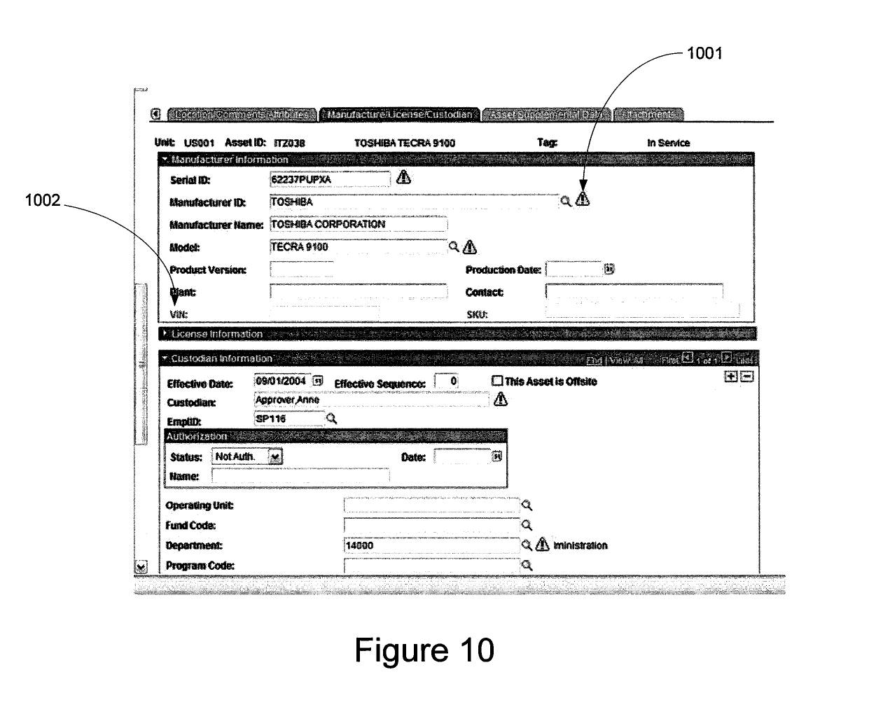

FIG. 10 shows another example of an asset information computer screen. An indicator 1001 indicates a discrepancy. Some attributes are not relevant for certain assets or certain types of assets. For example, the system may not show or gray out irrelevant fields. In this screen, a VIN field 1002 is grayed out because a laptop does not have VIN number.

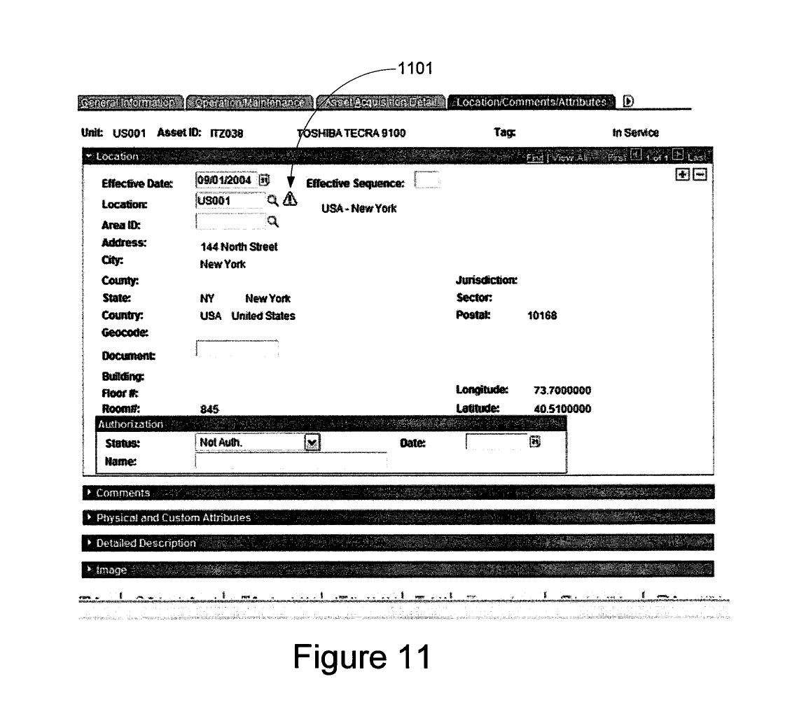

FIG. 11 shows another example of an asset information computer screen. An indicator 1101 indicates a discrepancy.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
providing proposed asset information to be entered into a first repository; and
before entering the proposed asset information into the first repository, comparing the proposed asset information with asset information in a second repository to find any discrepancies.

2. The method of claim 1 comprising:
if there are no discrepancies, entering the proposed asset information into the first repository; and
if there are discrepancies, showing the discrepancies between the proposed asset information with asset information in a second repository.

3. The method of claim 2 comprising:
after comparing the proposed asset information with the second repository and before entering the proposed asset information into the first repository, providing a user interface that allows altering of the proposed asset information.

4. The method of claim 3 comprising:
entering into the first repository either the proposed asset information without alteration or the proposed asset information with alterations made using the user interface.

5. The method of claim 1 comprising:
after the comparing the proposed asset information to the second repository, seeking an approval from the user to enter the proposed asset information into the first repository; and
receiving an approval from a user, entering the proposed asset information into the first repository.

6. The method of claim 1 comprising:
showing the discrepancies between the proposed asset information with asset information in a second repository; and
after receiving an approval from a user, entering the proposed asset information into the first repository.

7. The method of claim 6 wherein the proposed asset information to be entered comprises multiple assets.

8. The method of claim 1 comprising:
performing an automated asset discovery process to generate the second repository comprising discovered asset information.

9. A method comprising:
providing proposed asset information to be entered into a first repository;
if a first condition is satisfied, entering the proposed asset information into the first repository; and
if the first condition is not satisfied and before entering the proposed asset information into the first repository, comparing the proposed asset information with asset information in a second repository to find any discrepancies.

10. The method of claim 9 wherein the first condition is satisfied when the proposed asset information is not found in the second repository.

11. The method of claim 9 wherein the first condition is satisfied when the proposed asset information is indicated as not being in the second repository.

12. The method of claim 9 comprising:
if a second condition is satisfied, entering the proposed asset information into the first repository; and
if the second condition is not satisfied, showing the discrepancies between the proposed asset information with asset information in a second repository.

13. The method of claim 12 wherein the second condition is satisfied when there are no discrepancies.

14. A method comprising:
providing proposed asset information and discovery asset information;
comparing the proposed asset information to the discovery asset information;
displaying on a first screen an indicator of a discrepancy between the proposed asset information and the discovery asset information;
in the first screen, allowing a user to make changes to the proposed asset information; and
after allowing the user to make changes to the proposed asset information, saving the proposed asset information with any changes to an asset repository database.

15. The method of claim 15 wherein the providing proposed asset information initiates a synchronous communication resulting in the comparing the proposed asset information and discovery asset information.

16. The method of claim 14 wherein the proposed asset information is stored in a temporary memory location.

17. The method of claim 14 comprising:
before displaying the first screen, displaying a second screen for the user to enter the proposed asset information, wherein the second screen includes a user-selectable option; and
when the user-selectable option is not selected, the proposed asset information is saved to the asset repository without performing the comparing the proposed asset information and discovery asset information.

18. The method of claim 14 wherein in the first screen, moving a mouse cursor over an indicator of a discrepancy shows discovery asset information.

19. The method of claim 14 wherein the discovery asset information is compiled through automatic discovery.

20. The method of claim 14 wherein the first screen has a link, when selected, causes displaying of a second screen where the proposed asset information is provided in a first column and the discovery asset information is provided in a second column, adjacent to the first column.
